(19) United States
(12) Patent Application Publication
(10) Pub. No.: US 2021/0040737 A1
(43) Pub. Date: Feb. 11, 2021

(54) DEMOUNTABLE MODULAR WALL STRUCTURES

(71) Applicant: WeWork Companies LLC, New York, NY (US)

(72) Inventors: Aaron David Mendonça, Brooklyn, NY (US); Elizabeth Pipal, Brooklyn, NY (US); Laura Marie Peterson, Brooklyn, NY (US); Ben Perkins, New York, NY (US); Matthew Distin, New York, NY (US)

(21) Appl. No.: 16/920,149

(22) Filed: Jul. 2, 2020

Related U.S. Application Data
(60) Provisional application No. 62/870,520, filed on Jul. 3, 2019.

(51) Int. Cl. E04B 2/74; E04B 2/76

(52) U.S. Cl. CPC E04B 2/7433; E06B 7/096; E04B 2/767; E04B 2/7412

(57) ABSTRACT

Modular structures for creating functional spaces are disclosed herein. The modular structures can include partitions, such as walls, storefronts, and/or doors that can be easily assembled in a desired space and selectively paired together to create a desired floorplan suitable for the environment. These modular structures can be used together to create a suitable layout for a co-working space, an office environment, a school, a hospital, a laboratory, a factory, and various other indoor spaces.

### CROSS-REFERENCE TO RELATED APPLICATIONS

This application claims priority to U.S. Provisional Patent Application No. 62/870,520, filed Jul. 3, 2019, entitled DEMOUNTABLE MODULAR WALL STRUCTURES, the disclosure of which is incorporated herein by reference in its entirety.

### TECHNICAL FIELD

The present technology is generally directed to modular structures for creating functional spaces. In particular, several embodiments of the present technology are related to modular walls for partitioning an open floor plan into conference rooms and offices.

### BACKGROUND

Many workers in service or other industries typically use or need an office in which to work, which often takes the form of thousands of square feet of office space leased or owned by the worker's employer. Some workers are self-employed or work for small companies that may have a more difficult time finding an acceptable space in which to work. These self-employed or small company workers, as well as workers for large businesses, have turned to coworking arrangements.

Coworking is a self-directed, collaborative, and flexible work style, often based around a common interest, such as geographic location, shared social values, etc. Coworking typically employs a shared workplace and independent activities among individuals working within the workplace. Unlike a typical office, coworking often allows workers from different organizations to share resources, such as conference rooms, break rooms, receptionists, IT professionals, telecommunications resources, etc.

Coworking arrangements can be particularly attractive to work-at-home professionals, independent contractors, people in academia, independent scientists, and people who travel frequently—typically workers who would otherwise end up working in relative isolation or environments not specifically suited for a working environment (e.g., coffee shop). Coworkers can enjoy a social gathering of a group of people who are still working independently or in small groups, but who may share certain values and who are interested in the synergy that can happen from working with people who value working in the same place alongside each other. Thus, coworking offers a solution to the problem of isolation that many freelancers experience while working at home, while at the same time letting them escape the distractions of home and providing them with office-like features and capabilities not necessarily provided in a home office. Larger businesses with numerous employees in one geographic location also see the value in offering coworking arrangements for some of their employees, who can enjoy the same benefits noted above even if they represent a majority of the people in the coworking space. Further, for individuals, emerging companies, and larger corporations alike, coworking spaces also remove the need to find, rent, purchase, configure, outfit, supply, and/or manage their own space.

### BRIEF DESCRIPTION OF THE DRAWINGS

FIG. 1A is a partially schematic illustration of a co-working space configured in accordance with embodiments of the present technology.

FIGS. 1B-1D are perspective views of representative modular partitions for use in the co-working space of FIG. 1A.

FIG. 2 is a perspective view of a modular partition system installed within an interior of a building in accordance with embodiments of the present technology.

FIGS. 3A and 3B are front and side perspective views, respectively, of a modular partition system including louvered and non-louvered window cassettes in accordance with embodiments of the present technology.

FIG. 4 is an exploded perspective view of a modular partition system leveling assembly in accordance with embodiments of the present technology.

FIGS. 5A and 5B are partially assembled partial perspective views of the window cassette shown in FIGS. 3A and 3B.

FIGS. 6A and 6B are partial perspective views illustrating a vertical mullion and window casing fitment for the modular partition system shown in FIGS. 3A and 3B.

FIG. 7 is a partially assembled partial perspective view illustrating a horizontal mullion and window casing fitment for the modular partition system shown in FIGS. 3A and 3B.

FIGS. 8A and 8B are partially exploded and assembled perspective views, respectively, of a modular partition system in accordance with embodiments of the present technology illustrating the fitment of a louvered cassette.

FIG. 9 is an exploded perspective view of the louvered cassette shown in FIGS. 8A and 8B.

FIGS. 10A and 10B are enlarged perspective views illustrating a louver synchronization mechanism in accordance with embodiments of the present technology.

FIG. 11 is a perspective view illustrating the louver mechanism of FIGS. 10A and 10B.

FIGS. 12A and 12B are partially exploded and assembled perspective views, respectively, illustrating a fitment of a louver mechanism cover configured in accordance with embodiments of the present technology.

FIG. 13 is a partial perspective view of a louver synchronization mechanism in accordance with an embodiment of the present technology.

FIG. 14 is an exploded partial perspective view of the louvered cassette shown in FIGS. 8A-9 illustrating connection features for assembling modular wall structures in accordance with embodiments of the present technology.

FIG. 15 is a cross-sectional side view illustrating connection features for assembling modular wall structures in accordance with embodiments of the present technology.

FIGS. 16A and 16B are front and side perspective views of a modular partition system in accordance with embodiments of the present technology.

FIGS. 17A and 17B are perspective views of a top portion and a bottom portion, respectively, of the modular partition system shown in FIGS. 16A and 16B.

FIGS. 18A and 18B are front and side perspective views, respectively, of a modular partition system in accordance with embodiments of the present technology.

FIGS. 19A and 19B are front and side perspective views, respectively, of a modular partition system in accordance with embodiments of the present technology.

FIGS. 20A and 20B are perspective views of a base portion of the modular partition system shown in FIGS. 19A and 19B during successive stages of assembly.

FIG. 21 is a side cross-sectional view of a modular partition system in accordance with embodiments of the present technology.

FIG. 22 is a front elevational view of a modular wall structure illustrating dimensions of a wall installation in accordance with embodiments of the present technology.

### DETAILED DESCRIPTION

The present disclosure is directed generally toward modular structures and devices configured to be installed within buildings, such as office buildings, and associated systems and methods. Demountable modular wall structures and systems in accordance with the present technology can include a frame easily mounted between a bulkhead and a floor of a building to create walls and/or doors that together form the overall layout of an otherwise empty indoor space. For example, these modular partitions and the modular structures therein can create meeting rooms, offices, cubicles, acoustically insulated rooms, retail space, bathrooms, and other types of partitioned areas used in offices and other functional indoor spaces, such as healthcare and educational facilities. In some embodiments, a plurality of acoustically-insulating panels can be coupled to the frame to form a solid wall between the floor and the bulkhead to, for example, separate and form a meeting room from a larger space in an office. In other embodiments, a plurality of glazings can be coupled to the frame to form a transparent wall between the floor and the bulkhead to, for example, separate and form an individual office from the larger space in the office. In some aspects of the present technology, the glazings and/or the panels can be coupled to the frame via a snap-fit or other arrangement that does require many—if any—fasteners or adhesives. This can facilitate the quick and easy assembly of the system and provide increased flexibility in the selection/manipulation of the floor plan of the office.

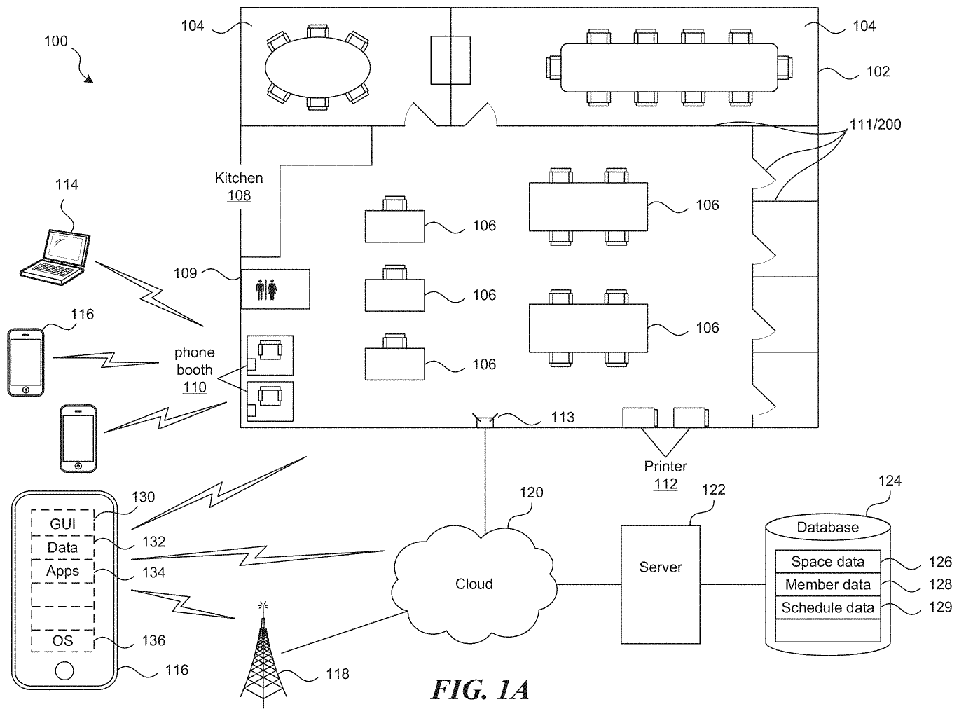

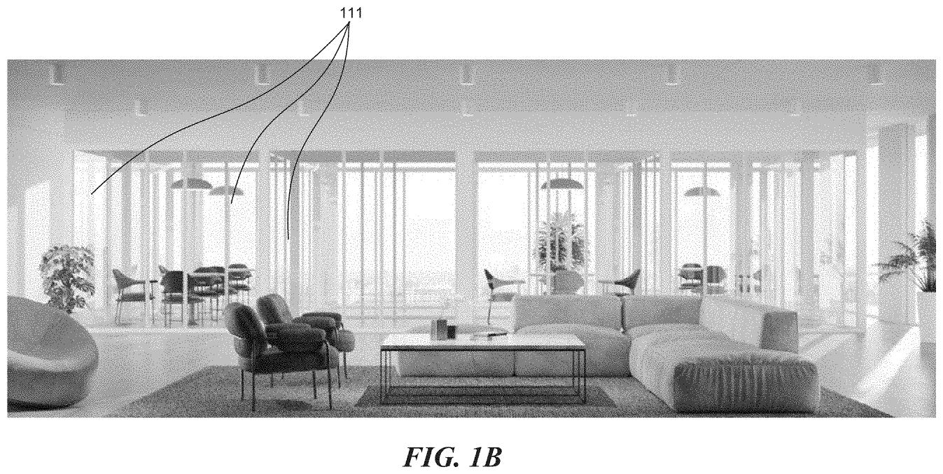

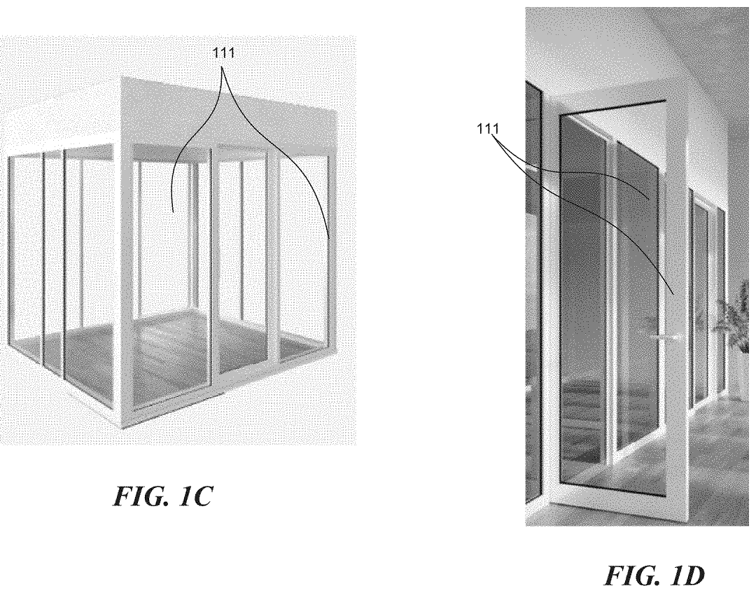

Certain details are set forth in the following description and in FIGS. 1A-22 to provide a thorough understanding of various embodiments of the present technology. For example, numerous embodiments of modular structures and devices are described with respect to creating environments and structures in an office setting. However, the embodiments disclosed herein can be used in other types of indoor facilities to create functional spaces for different purposes. For example, the modular wall structures can be used to create functional facilities that serve as retail space, store fronts, schools, hospitals, research institutions, laboratories, factories, and living facilities (e.g., dormitories, residential spaces). In other instances, well-known structures, materials, operations and/or systems often associated with walls, glazings, etc.—such as fasteners, connecting devices, etc.—are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles, and other features shown in the Figures are merely illustrative of particular embodiments of the disclosure. Accordingly, other embodiments can have other details, dimensions, angles, and features without departing from the spirit or scope of the present technology. In addition, those of ordinary skill in the art will appreciate that further embodiments of the invention can be practiced without several of the details described below.

### I. Overview of Selected Embodiments of Modular Spaces

Several implementations are discussed below in more detail with reference to the figures. FIG. 1A illustrates an overview of an environment 100 in which some implementations of the disclosed technology can operate. The environment 100 includes a co-working facility 102 that includes conference rooms 104, desks 106, a kitchen area 108, and a restroom 109. The co-working facility 102 also includes additional resources, such as phone booths 110 and printers 112, as well as IT infrastructures such as wireless routers 113 to provide wireless local networking (e.g. IEEE 802.11 Wi-Fi networking), networked or “smart” thermostats, smart lighting, and so forth.

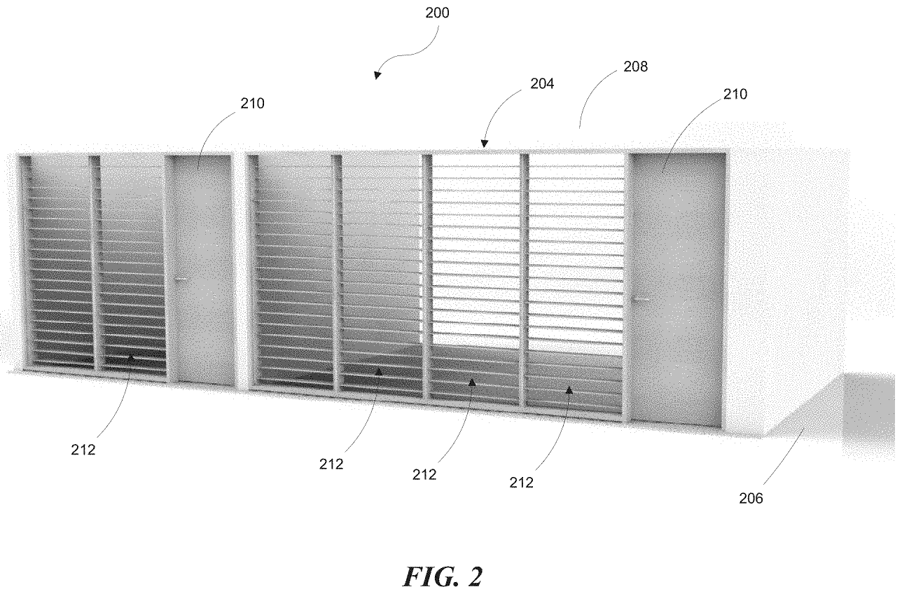

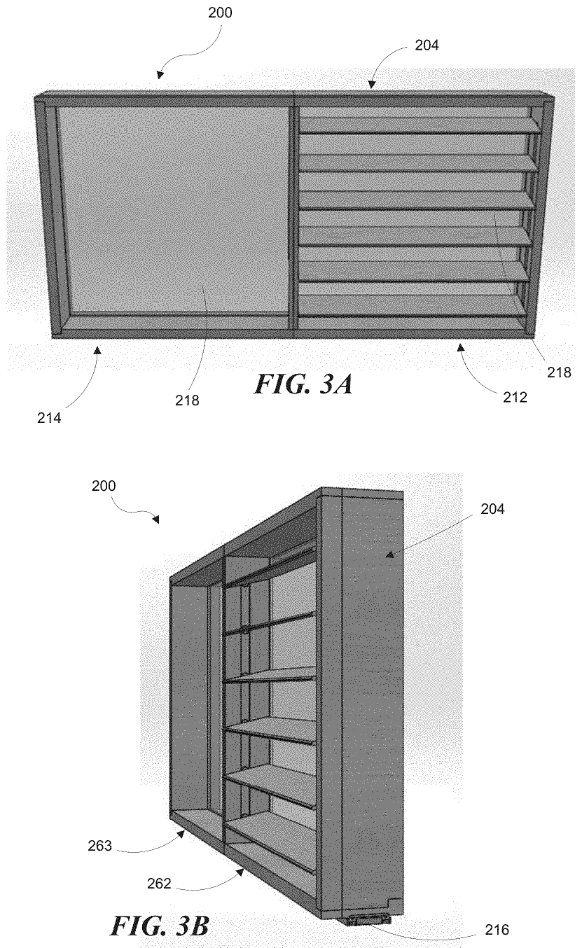

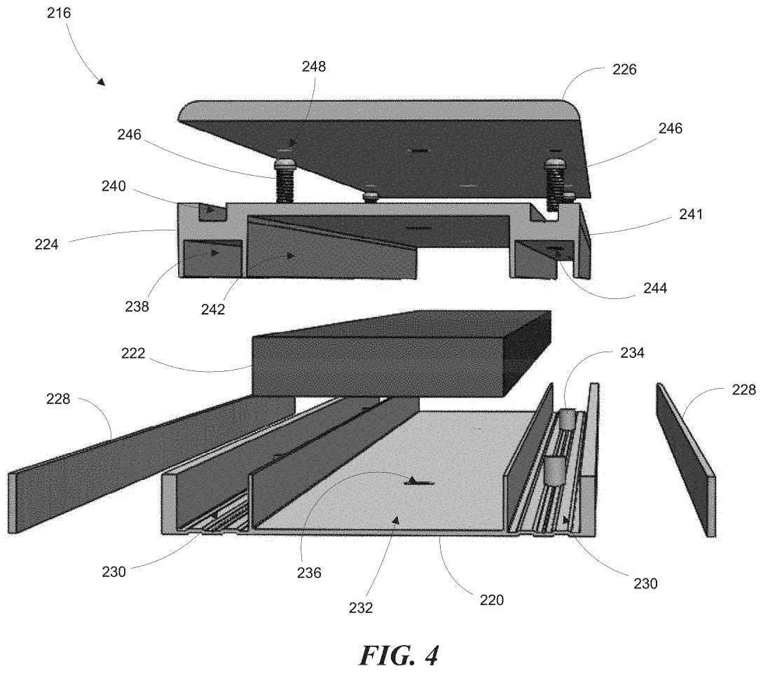

Some or all of the rooms and/or other structures in the co-working facility 102 can be defined at least in part by various modular structures, such as modular partitions 111 and/or 200 that can be easily and expeditiously installed in the co-working space 102 to create a desired floorplan. The modular partitions 111/200 can include acoustically insulated wall structures, partitions made of glass and/or other transparent or partially transparent materials, partitions made of opaque materials, partitions including sliding and/or swinging doors, wall structures including movable louvers, partitions that provide for electrical cabling, and/or various other suitable partitions and features on the partitions for creating the desired layout for a co-working or other office environment. FIGS. 1B-1D, for example, illustrate modular partitions 111 configured in accordance with embodiments of the present technology. The modular partitions 111 can create one or more walls mounted between a ceiling or header and the floor to define one or more meeting rooms (FIG. 1B) and/or offices (FIG. 1C) that may be accessible via a sliding door (FIG. 1C) or swinging door (FIG. 1D) that is part of the modular partitions 111. FIG. 2, for example, illustrates a modular partition system 200 configured in accordance with embodiments of the present technology. The modular partition system 200 can create one or more walls mounted between a ceiling or header 208 and the floor 206 to define a store front, for example. The modular partition system 200 can include a partition frame 204, doors 210, and multiple modular structures (e.g., modules) or cassettes. The embodiment depicted in FIG. 2 includes multiple louvered window cassettes 212 positioned in the partition frame 204, for example. In some embodiments, the partition frame, cassette frames, and louvers can comprise wood to provide a cohesive yet sustainable wooden storefront system suitable for everyday office space. The modular partition system 200 can be mounted on a novel leveling assembly (FIGS. 3B-4) allowing these modular wall structures to be demounted from the floor and header. Thus, these modular structures can expedite the configuration of an office space, for example, and/or allow for simple reconfiguration of the office space.

As further shown in FIG. 1A, the co-working facility 102 and/or members occupying the co-working facility 102 typically have one or more laptop computers 114, mobile phones 116, and other data processing devices that can connect to one or more servers 122 via the wireless routers 113 or via WWAN/cellular base stations 118 and via a network or cloud 120. While server 122 is displayed logically as a single server 122, the system can employ a distributed computing environment encompassing multiple computing devices located at the same or at geographically disparate physical locations. The network or cloud 120 can be any network, ranging from a wired or wireless local area network (LAN), to a wired or wireless wide area network (WAN), to the Internet or some other public or private network. The server 122 is coupled to one or more databases 124. The database 124 stores data such as space data 126, member data 128 and schedule data 129. The space data 126 includes data related to physical layout and resources within the co-working facility 102. The member data 128 includes information regarding members who work within the facility 102, and can include information regarding rental or lease data, personal information, preferences, and so forth. The schedule data 129 includes information regarding scheduling of resources within the facility 102, such as the conference rooms 104, desks 106, and so forth. Members and/or those managing the co-working facility 102 can access various aspects of this information via one or more applications running on the laptop 114 or mobile device 116. As shown, the mobile device 116 can include an operating system 136, one or more applications 134, application data 132 and a graphical user interface (GUI) 130. While the connections between the server 122 and the cloud 120 and database 124 are shown as separate connections, these connections can be any kind of local, wide area, wired, or wireless network, public or private.

Various aspects of the co-working facility 102 can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

In the embodiment shown in FIG. 1A, the modular structures and other features of the facility 102 are described with respect to a co-working space. However, the modular structures and other features described herein may be suitable to for use in other environments that are partitioned to create a specific layout. For example, the modular partitions 111/200 and/or other modular structures disclosure herein can be used to define rooms and bathrooms for a school environment, clean rooms and partitioned spaces for a laboratory, patient rooms and nurse's facilities in hospitals, sleeping quarters and living spaces for temporary or permanent housing, and so forth.

II. Selected Embodiments of Systems Having Modular Glass and/or Louvered Structures

FIGS. 3A and 3B are perspective views of the modular partition system 200 (“system 200”) in accordance with embodiments of the present technology. In the depicted configuration, the system 200 includes a louvered cassette 212, a window cassette 214, a partition frame 204, and a leveling assembly 216. In the illustrated embodiment, the louvered cassette 212 and the window cassette 214 can each include a glazing 218 (which can also be referred to herein as windows, glass panes, glass sheets, etc.). As explained more fully below, each cassette includes a cassette frame that is positioned in the partition frame 204. For example, the louvered cassette 212 includes a cassette frame 262 and the window cassette 214 includes a cassette frame 263. The corresponding glazing 218 is captured between its corresponding cassette frame and the partition frame 204. In some embodiments, the glazings 218 can comprise laminate glass having an approximate thickness of 10 mm. In some embodiments, whiteboard and/or chalkboard can be substituted for one or more of the glazings, for example.

The louvered cassette 212, the window cassette 214, and the surrounding partition frame 204 are positioned on the leveling assembly 216. The leveling assembly 216 is operative to level the modular partition and urge the modular partition against the header 208 (FIG. 2). Referring to FIG. 4, the leveling assembly 216 can include a base member 220, a mating platform member 224, and an acoustic element 222 positioned therebetween. In some embodiments, the acoustic element 222 can comprise foam tape with adhesive on one or more sides. The acoustic element 222 can be disposed in a central channel 232 which extends between two lateral channels 230. The platform member 224 also includes a central platform channel 242 to receive the acoustic element 222. It should be understood that the acoustic element 222 can be compressed between the base member 220 and the mating platform member 224 when the leveling assembly 216 is assembled.

The base member 220 can include a plurality of centrally positioned mounting holes 236 spaced e.g., 250 mm-500 mm apart. The mounting holes 236 facilitate mounting the base to the floor with suitable mounting fasteners such as 8 mm masonry screws (not shown).

The platform member 224 includes a pair of lateral rails 241 located on either side of the central channel 242 and sized to mate with the lateral channels 230 of the base member 220. Each lateral rail 241 includes a clearance channel 238 to accommodate threaded inserts 234 positioned in the lateral channels 230 of the base member 220. Each lateral rail 241 also includes a fastener channel 240 formed in the platform member 224 opposite a corresponding clearance channel 238. The fastener channels 240 are sized to receive the head portion of fasteners 246. The fasteners 246 extend through clearance holes 244 and thread into corresponding threaded inserts 234.

The fasteners 246 are captured in the platform member 224 by a platform cap 226 that is secured to the platform member 224. The platform cap 226 can be welded to the platform member 224 or fastened thereto with suitable fasteners (not shown), for example. The platform cap 226 includes a plurality of adjustment holes 248 aligned with corresponding fasteners 246. In some embodiments, the fasteners 246 can comprise round head hex drive screws. Thus, a hex tool (e.g., Allen wrench) can be inserted through adjustment holes 248 to engage the fasteners 246.

When assembled, the fasteners 246 are threaded into the mating threaded inserts 234. Tightening (e.g., rotating clockwise) the fasteners 246 compresses the acoustic element 222. As the fasteners 246 are loosened (e.g., rotated counterclockwise) the head portion of the fasteners 246 pushes against the underside of the platform cap 226, thereby raising the platform cap 226 and platform member 224 to provide leveling and height adjustment for the modular partition system. In some embodiments, the leveling assembly 216 can provide up to approximately 15 mm of adjustment.

The base member 220, the platform member 224, and the platform cap 226 can each be comprised of an aluminum extrusion, for example. Wooden strips or veneers 228 can be attached to the base member 220 to conceal the aluminum finish of the base member 220 in order to maintain a consistent wood finish throughout the modular partition system.

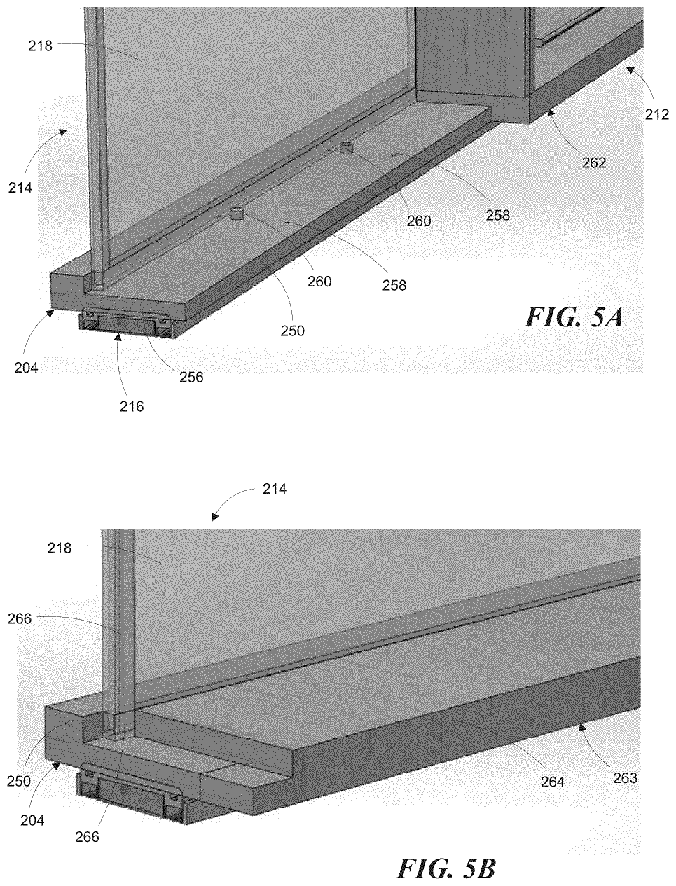

As shown in FIG. 5A, the partition frame 204 can include one or more L-shaped horizontal casing members 250 positioned on top of the leveling assembly 216. In some embodiments, the casing member 250 can include a groove 256 configured to receive the platform cap 226 (FIG. 4) thereby keeping the partition frame 204 aligned with the leveling assembly 216. The casing member 250 can include a plurality of access holes 258 to allow access to the fasteners 246 (FIG. 4) for adjustment.

With reference to FIG. 5B, the frame 263 of window cassette 214 includes an L-shaped horizontal mullion 264 configured to mate with the horizontal casing member 250. In some embodiments, the horizontal mullion 264 and the horizontal casing member 250 can be aligned and joined together with dowels 260 (FIG. 5A), for example. The horizontal mullion 264 and the horizontal casing member 250 are configured to leave a gap therebetween in which the glazing 218 is captured. Gaskets 266 can be placed around the glazing 218. The gaskets 266 can comprise U-shaped gaskets manufactured from transparent polypropylene, for example.

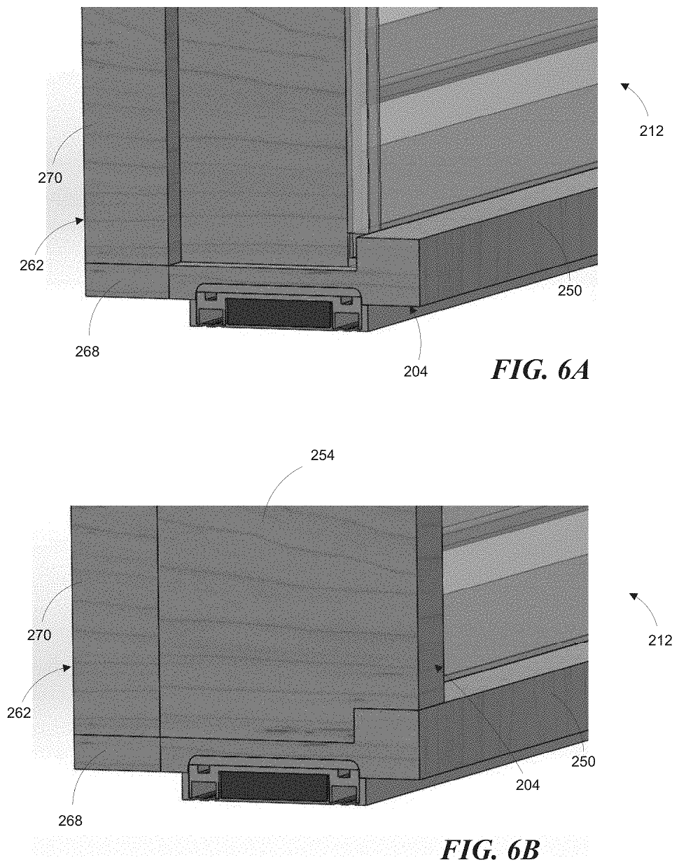

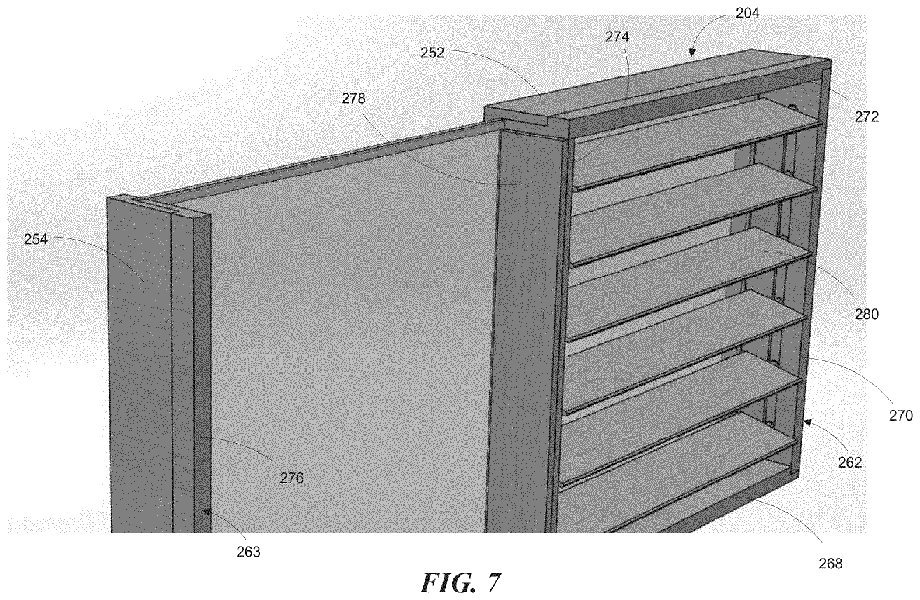

As shown in FIG. 6A, the louvered cassette frame 262 includes a lower horizontal mullion 268 and an outer vertical mullion 270. With reference to FIG. 6B, the partition frame 204 includes a vertical casing member 254 that mates with both the horizontal casing member 250 and the vertical mullion 270. With further reference to FIG. 7, the louvered cassette frame 262 also includes an upper horizontal mullion 272 and an inner vertical mullion 274. The window cassette frame 263 includes an outer vertical mullion 276 and an inner vertical mullion 278. It should be appreciated that the louvered cassette frame 262 and the window cassette frame 263 can be similarly constructed with horizontal and vertical mullions. However, the vertical mullions 270 and 274 of the louvered cassette frame 262 include provisions for mounting a plurality of louvers 280. The partition frame 204 can also include one or more upper horizontal casing members 252.

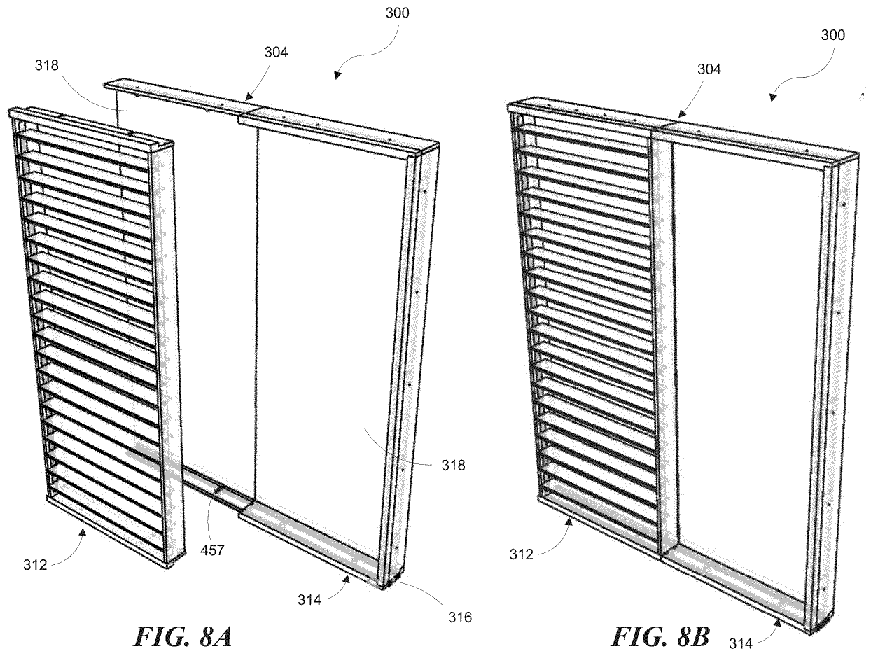

FIGS. 8A and 8B illustrate a modular partition system 300 configured in accordance with embodiments of the present technology. The modular partition system 300 is similar to the modular partition system 200 described above with respect to FIGS. 2-7. The system 300 includes a louvered cassette 312, a window cassette 314, a partition frame 304, and a leveling assembly 316. As shown in FIGS. 8A and 8B, the louvered cassette 312 and the window cassette 314 can each be inserted into the partition frame 304 as assembled units. Each cassette captures a glazing 318 between the cassette's frame and the partition frame 304.

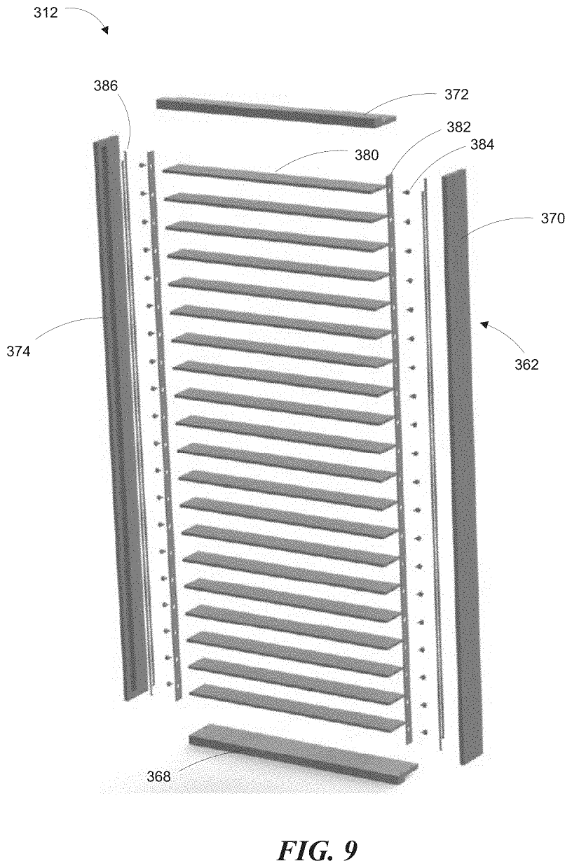

FIG. 9 is an exploded view illustrating the components of the louvered cassette 312. The cassette 312 includes a cassette frame 362 that carries multiple louver blades 380. The cassette frame 362 can include upper and lower horizontal mullions 372 and 368 and left and right vertical mullions 374 and 370. Each louver blade 380 is carried by a pair of cogs 384. The cogs 384 engage synchronization gear racks 386 which cooperate to keep the louvers aligned with each other as they are rotated. The synchronization gear racks 386 can be enclosed by a cover strip 382 to hide the gear racks from view. The cover strip 382 can also locate the cogs 384 along the vertical mullions.

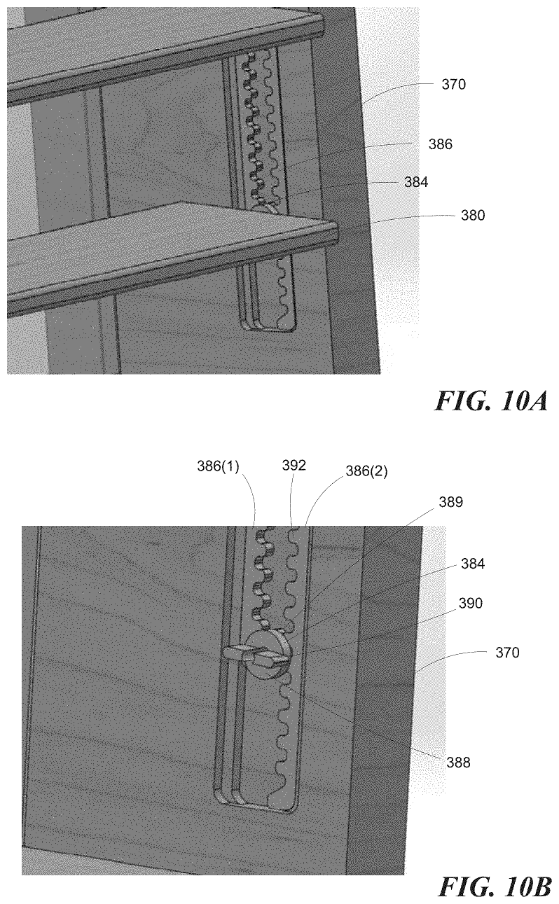

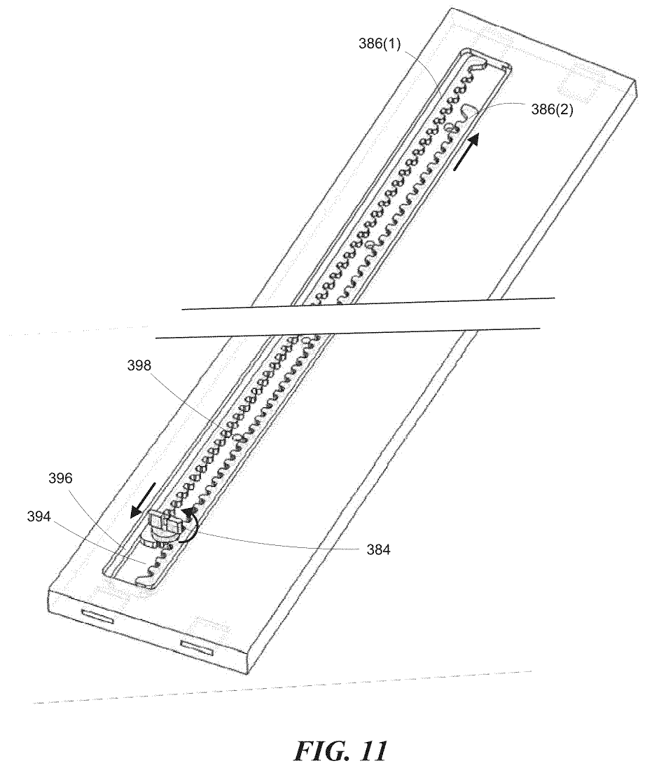

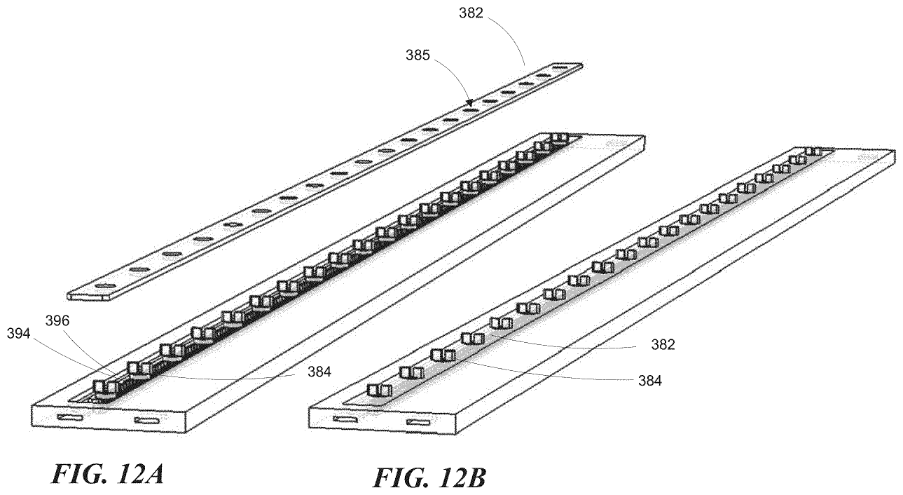

As shown in FIGS. 10A and 10B, the cogs 384 can include a disc portion 388 with a gear 389 and a tab 390 extending from opposite sides of the disc portion 388. The tab 390 is configured to insert into a mating slot (not shown) formed in the end of the louver 380. The gear 389 engages teeth 392 formed along the synchronization gear racks 386(1) and 386(2). With further reference to FIG. 11, the synchronization gear racks 386(1) and 386(2) move (e.g., slide) in opposite directions as the cogs 384 are rotated. The synchronization gear racks 386(1) and 386(2) are positioned on opposite sides of a slot 394. During assembly, the synchronization gear racks 386(1) and 386(2) can also be positioned on opposite ends of the slot 394 to facilitate proper assembly and alignment of the cogs 384. The slot 394 includes shoulders 396 to support the cover strip 382 (FIG. 9). In some embodiments, multiple pilot holes 398 are formed along the slot 394 to receive pivot pins (not shown) extending from the gear 389 of each of the cogs 384. As shown in FIGS. 12A and 12B, the cover strip 382 can include a plurality of cog openings 385, each corresponding to a cog 384. The cover strip 382 can be positioned in slot 394 and glued to shoulders 396, for example.

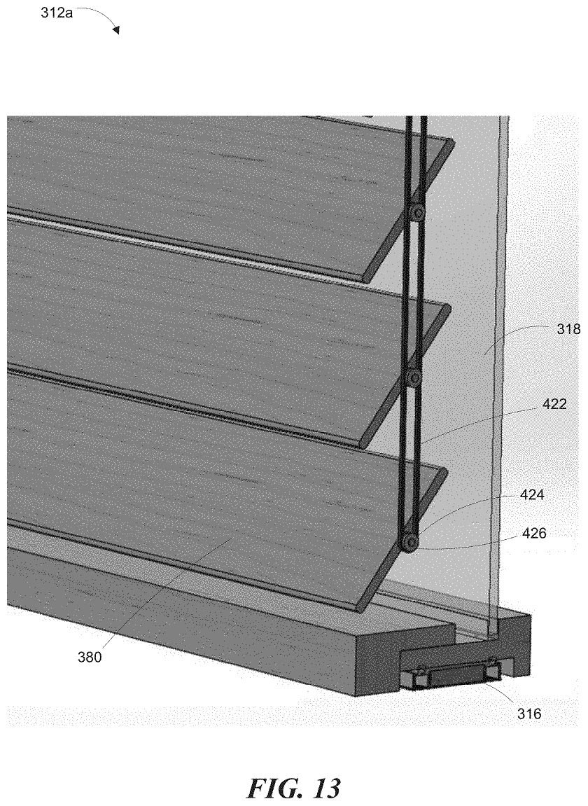

FIG. 13 illustrates a louvered cassette 312a including a louver synchronization mechanism according to another embodiment of the present technology. In the depicted embodiment, the louvers 380 are synchronized by a band or belt 422 that extends around and engages pulleys 426 attached to each end of the louvers 380. The pulleys 426 can be attached to the louvers with suitable fasteners or a mounting pin 424, for example.

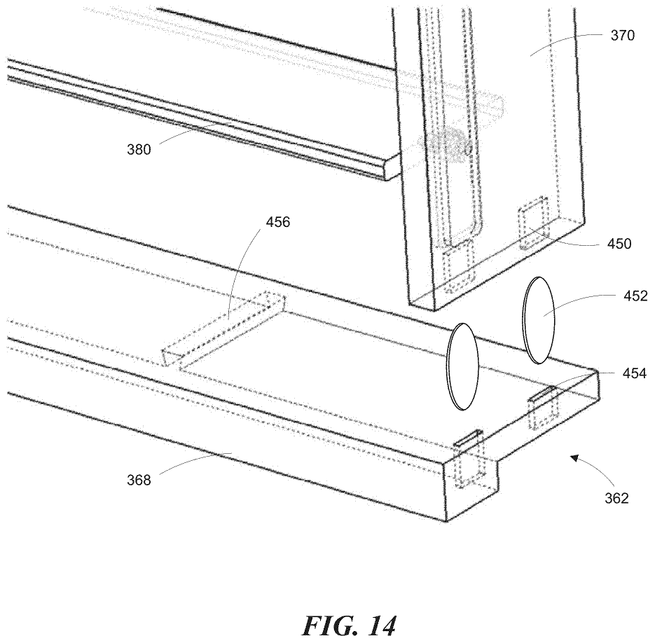

As shown in FIG. 14, the cassette frame 362 can be assembled with various connection and joinery features and techniques. For example, the vertical mullion 370 can be secured to the horizontal mullion 368 with biscuits 452. The vertical mullion 370 and the horizontal mullion 368 can both include slots 450 and 454, respectively, that are positioned to receive the biscuits 452. The biscuits 452 can be glued in place to provide a secure joint. The horizontal mullion 368 can be secured to the partition frame 304 (FIG. 8A) with a dovetail arrangement. The horizontal mullion 368 can include one or more dovetail grooves 456 positioned to mate with a dovetail 457 (FIG. 8A) formed in the corresponding casing of the partition frame 304.

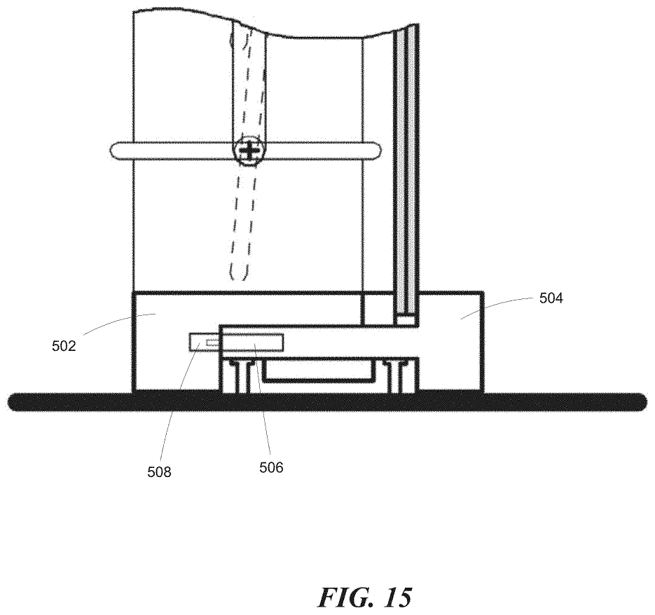

FIG. 15 illustrates another joining technique for joining the components of the partition systems disclosed herein. In the depicted embodiment, the horizontal mullion 502 can be joined to the casing member 504 with magnetically activated mating connectors 506 and 508. The connectors 506 and 508 are assembled into the wood of the horizontal mullion 502 and the horizontal casing member 504 such that when assembled the connectors are not visible. The two connectors 506 and 508 are joined together with a rotating magnet that drives one of the two connectors (e.g., connector 508) to thread into the other connector thereby joining the mullion and casing member together. Suitable magnetic drive fasteners and tools are available from Lamello, such as the Invis Mx2 invisible fastener system.

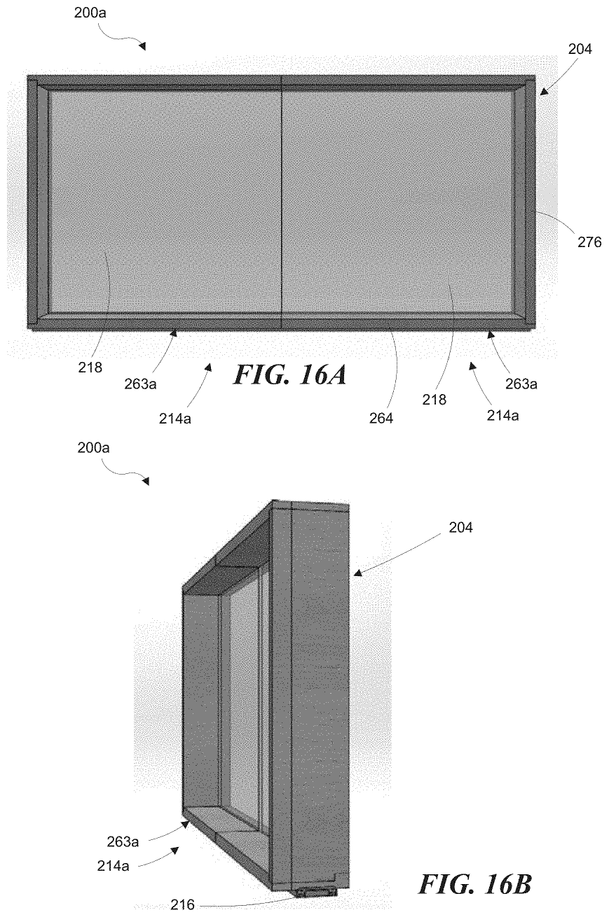

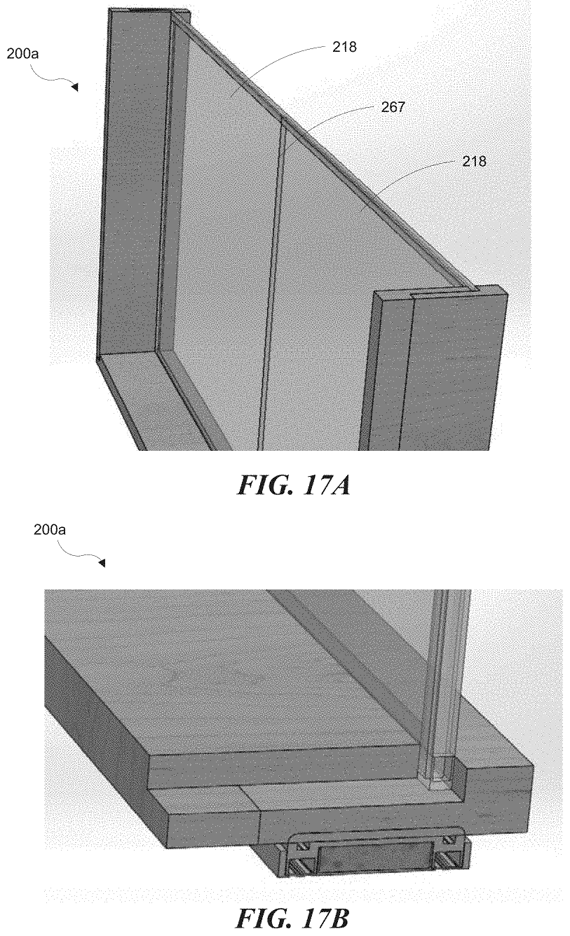

The partition systems disclosed herein can be assembled in different configurations using common components and assemblies, thus the modular nature of the disclosed partition systems. For example, as shown in FIGS. 16A and 16B, using the components discussed above with respect to FIGS. 2-7, a modular partition system 200a can be assembled having two window cassettes 214a. The window cassettes 214a vary from the above disclosed window cassettes 214 (FIG. 3A) in that their cassette frames 263a do not include inner vertical mullions which results in a large unobstructed window. Otherwise, the modular partition system 200a makes use of common components with system 200, such as the partition frame 204, glazings 218, leveling assembly 216, and the horizontal and vertical mullions (e.g., mullions 264 and 276). FIGS. 17A and 17B further illustrate the construction of the modular partition system 200a, which is similar to that of system 200 shown in FIGS. 5A-7, for example. In this configuration, the glazings 218 can be joined in the middle with gasket material 267, which is similar to the U-shaped gasket material 266 (FIG. 5B) but can have an H-shaped cross-section to receive the edges of two adjacent glazings 218.

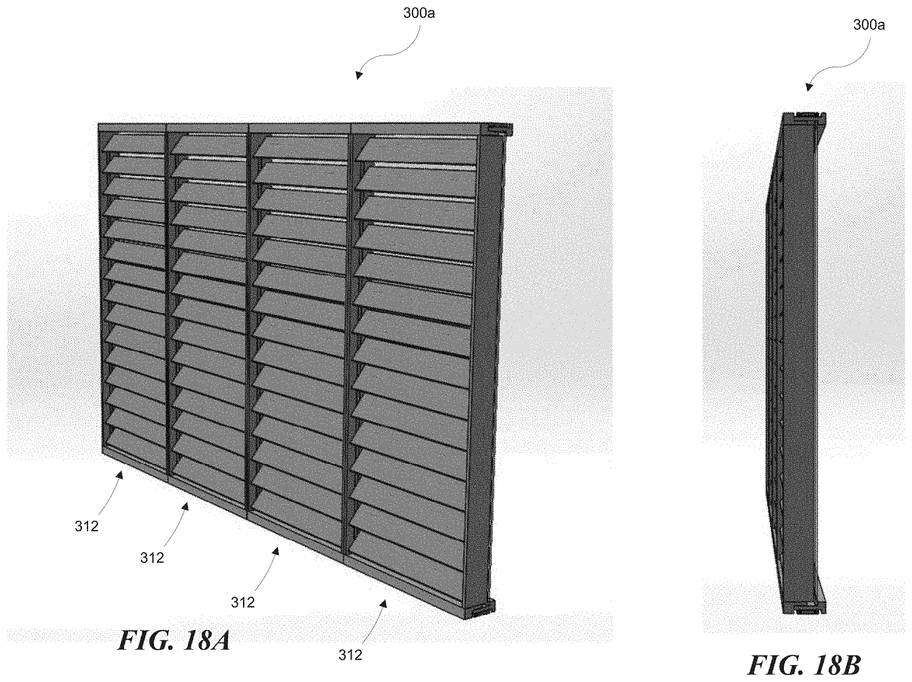

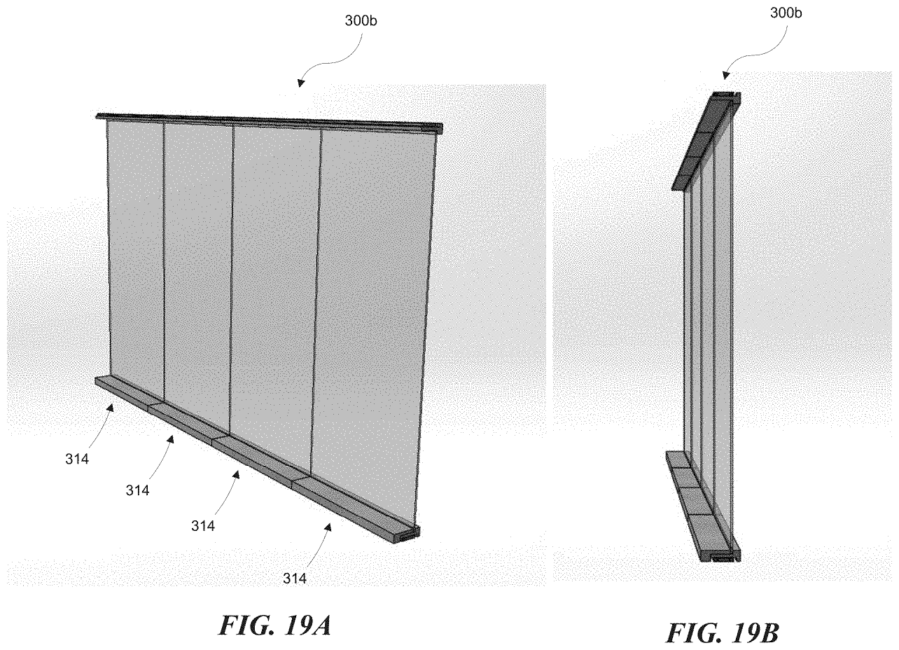

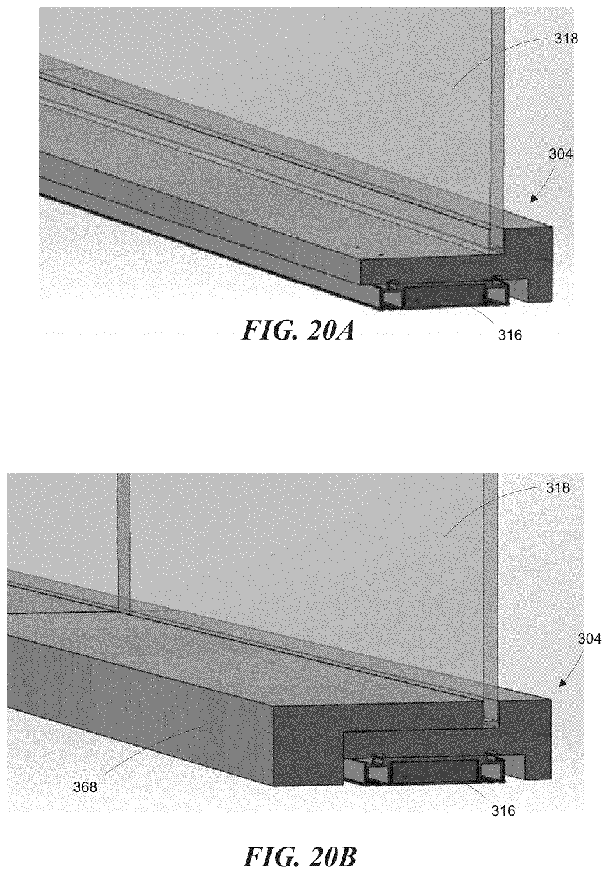

As shown in FIGS. 18A and 18B, the components discussed above with respect to FIGS. 8A-9, can be assembled to create a modular partition system 300a comprised of multiple louver cartridges 312. Some of these same components can be assembled to create a modular partition system 300b comprised of multiple window cartridges 314, as shown in FIGS. 19A-20B. For example, referring to FIGS. 20A and 20B, the partition frame 304, lower horizontal mullion 368, glazings 318, leveling assembly 316, and upper horizontal mullion 372 (FIG. 9) can be assembled to create the modular partition system 300b.

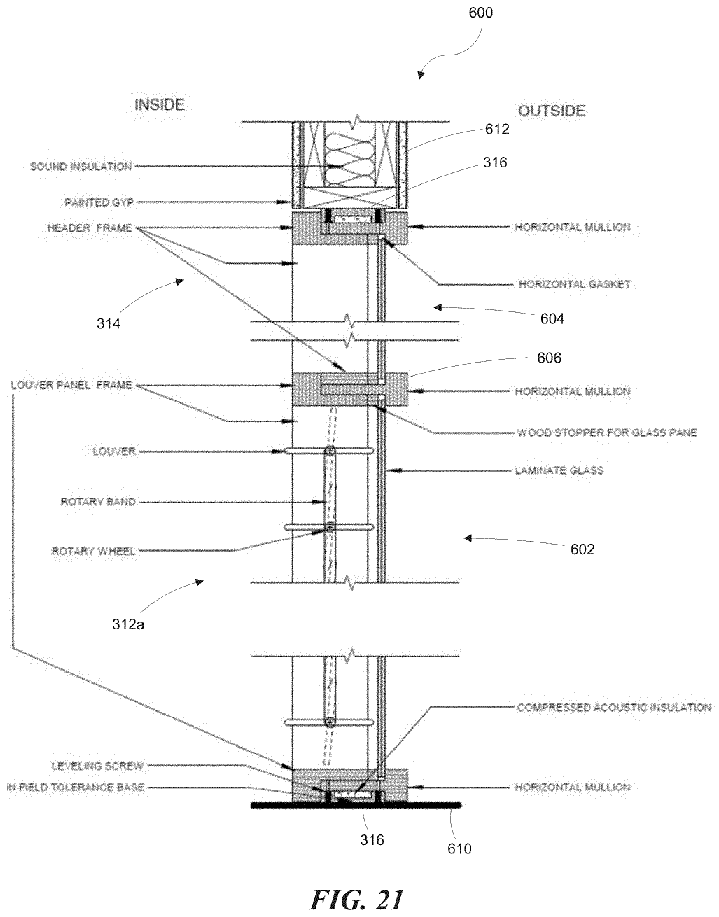

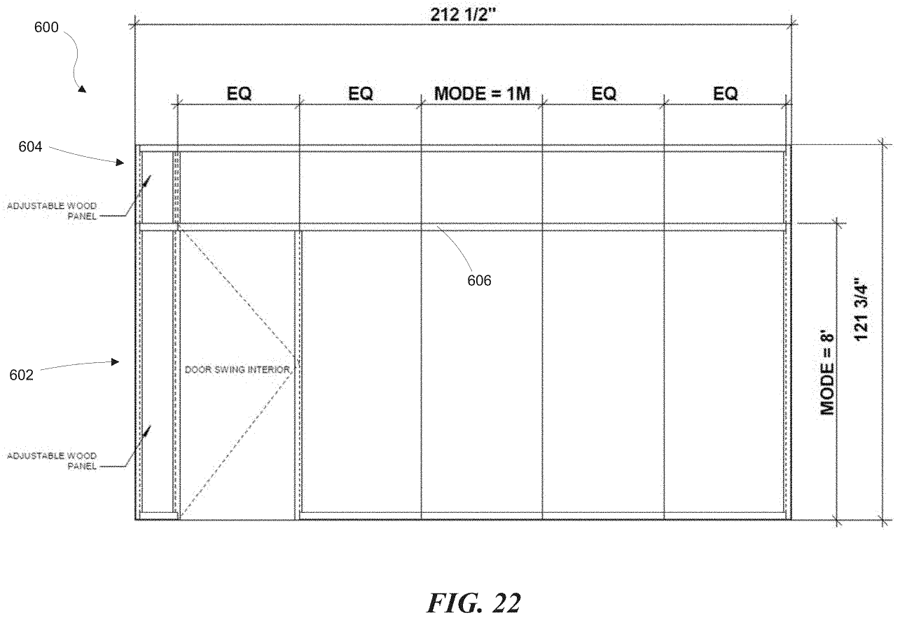

FIG. 21 is a side view in cross-section of a modular wall structure 600 in accordance with embodiments of the present technology. The modular wall structure 600 can incorporate components of the modular partition system 300 discussed above with respect to FIGS. 8A-9, for example. The modular wall structure 600 can include a main partition 602 and a transom window 604 divided by a transom 606. A transom window is a window or set of windows positioned above the transom or transverse horizontal crosspiece above a door or larger window. In the depicted embodiment, the main partition 602 is comprised of louvered cartridges 312a and the transom window 604 is comprised of window cartridges 314. The modular wall structure 600 is positioned between the floor 610 and a wall bulkhead or header 612. Leveling assemblies 316 can be positioned between the system 600 and the floor 610 as well as the wall header 612 in order to level and secure the system 600 in position. FIG. 22 is a front view in elevation of the modular wall structure 600 shown in FIG. 21 illustrating representative dimensions of a wall installation.

Although specific embodiments of, and examples for, the technology are described above for illustrative purposes, various embodiments are possible within the scope of the technology. For example, a modular partition system in accordance with embodiments of the present technology can comprise a partition frame, one or more louvered cassettes positioned in the partition frame, one or more window cassettes positioned in the partition frame, and a leveling assembly positioned between the partition frame and a support surface.

In some embodiments, the modular partition system can further comprise one or more glazings positioned between the one or more louvered cassettes and the one or more window cassettes and the partition frame. In some embodiments, each of the louvered cassettes and the window cassettes can include a corresponding cassette frame. In some embodiments, each of the louvered cassettes can include a cassette frame, multiple louver blades positioned in the cassette frame, and a synchronization mechanism coupled to the louver blades and operative to keep the louver blades aligned to each other as they are rotated. In some embodiments, the synchronization mechanism can comprise at least one cog attached to at least one end of each of the multiple louver blades and at least one pair of cooperative gear racks engaged with the cogs and operative to keep the louver blades aligned with each other as they are rotated. In some embodiments, the leveling assembly can comprise a base member including a central channel extending between two lateral channels, a mating platform member including a pair of lateral rails located on either side of a central platform channel and sized to mate with the lateral channels of the base member, and an acoustic element positioned between the base member and the platform member.

A leveling assembly in accordance with embodiments of the present technology can comprise a base member including a central channel extending between two lateral channels, a mating platform member including a pair of lateral rails located on either side of a central platform channel and sized to mate with the lateral channels of the base member, and an acoustic element positioned between the base member and the platform member.

In some embodiments, the acoustic element can comprise foam tape with adhesive on one or more sides, and wherein the acoustic element is compressed between the base member and the platform member when the leveling assembly is assembled. In some embodiments, the leveling assembly can further comprise a plurality of threaded inserts each positioned in a corresponding lateral channel of the base member. The platform member can include a pair of clearance channels each formed in a corresponding lateral rail to accommodate the threaded inserts, a pair of fastener channels each formed in a corresponding lateral rail opposite a corresponding clearance channel, and a plurality of clearance holes formed between the clearance channels and the fastener channels. A plurality of fasteners can each extend through a corresponding clearance hole to be threaded into a corresponding threaded insert. In some embodiments, the plurality of fasteners can be captured in the platform member by a platform cap that is secured to the platform member. In some embodiments, the platform cap can include a plurality of adjustment holes each aligned with a corresponding fastener. In some embodiments, the base member and the platform member can be comprised of extruded aluminum.

### V. Conclusion

The above detailed description of embodiments of the technology are not intended to be exhaustive or to limit the technology to the precise forms disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. The following claims provide further representative embodiments of the present technology.

What is claimed is:

1. A modular partition system, comprising:
a partition frame;
one or more louvered cassettes positioned in the partition frame;
one or more window cassettes positioned in the partition frame; and
a leveling assembly positioned between the partition frame and a support surface.

2. The modular partition system of claim 1, further comprising one or more glazings positioned between the one or more louvered cassettes, the one or more window cassettes, and the partition frame.

3. The modular partition system of claim 1, wherein each of the louvered cassettes and the window cassettes includes a corresponding cassette frame.

4. The modular partition system of claim 1, wherein each of the louvered cassettes includes:
a cassette frame;
multiple louver blades positioned in the cassette frame; and
a synchronization mechanism coupled to the louver blades and operative to keep the louver blades aligned to each other as they are rotated.

5. The modular partition system of claim 4, wherein the synchronization mechanism comprises:
at least one cog attached to at least one end of each of the multiple louver blades; and
at least one pair of cooperative gear racks engaged with the cogs and operative to keep the louver blades aligned with each other as they are rotated.

6. The modular partition system of claim 1, wherein the leveling assembly, comprises:
a base member including a central channel extending between two lateral channels;
a mating platform member including a pair of lateral rails located on either side of a central platform channel and sized to mate with the lateral channels of the base member; and
an acoustic element positioned between the base member and the platform member.

7. A leveling assembly, comprising:
a base member including a central channel extending between two lateral channels;
a mating platform member including a pair of lateral rails located on either side of a central platform channel and sized to mate with the lateral channels of the base member; and
an acoustic element positioned between the base member and the platform member.

8. The leveling assembly of claim 7, wherein the acoustic element comprises foam tape with adhesive on one or more sides, and wherein the acoustic element is compressed between the base member and the platform member when the leveling assembly is assembled.

9. The leveling assembly of claim 7, further comprising:
a plurality of threaded inserts each positioned in a corresponding lateral channel of the base member;
wherein the platform member includes:
a pair of clearance channels each formed in a corresponding lateral rail to accommodate the threaded inserts;
a pair of fastener channels each formed in a corresponding lateral rail opposite a corresponding clearance channel; and
a plurality of clearance holes formed between the clearance channels and the fastener channels; and
a plurality of fasteners each extending through a corresponding clearance hole and threaded into a corresponding threaded insert.

10. The leveling assembly of claim 9, wherein the plurality of fasteners are captured in the platform member by a platform cap that is secured to the platform member.

11. The leveling assembly of claim 10, wherein the platform cap includes a plurality of adjustment holes each aligned with a corresponding fastener.

12. The leveling assembly of claim 7, wherein the base member and the platform member are comprised of extruded aluminum.
